(19) United States
(12) Patent Application Publication
(10) Pub. No.: US 2006/0174134 A1
(43) Pub. Date: Aug. 3, 2006

(54) Secure steganographic biometric identification

(75) Inventor: Barry John Taylor, Elsternwick, Victoria (AU)

Correspondence Address: RICHARD M. GOLDBERG, 25 EAST SALEM STREET, SUITE 419, HACKENSACK, NJ, 07601, US

(73) Assignee: Grosvenor Leisure Incorporated, Mont Fleuri, Victoria, Mahe (SC)

(21) Appl. No.: 10/548,164

(22) PCT Filed: Mar. 4, 2004
(86) PCT No.: PCT/AU04/00278

§ 371 Date: Sep. 6, 2005

(30) Foreign Application Priority Data
Mar. 4, 2003 (AU) 2003900981

(51) Int. Cl. H04K 1/00

(52) U.S. Cl. 713/186

(57) ABSTRACT

Methods and apparatus are described for the positive identification of an individual wishing to undertake a financial transaction over a telecommunication medium. Financial, fingerprint and image data of an individual are encrypted and stored on a smart card. A person offering the card for a financial transaction has a fingerprint taken from which an encryption key is determined and used to decrypt the fingerprint and image data held on the card. If the fingerprint data obtained from the person matches the fingerprint data of the individual stored on the card, then the image stored on the card is displayed for further identification of the person. Devices are described which enable this identification method to be used in conjunction with an EFTPOS terminal or similar.

THIS INVENTION relates to the provision of a secure method for the positive identification of an individual, particularly, but not exclusively, as a means for the authentication of a purchase of goods or services or for cash withdrawals over a telecommunication medium. The invention finds particular, but not exclusive, use as a means for secure purchasing of goods or services over a visual medium such as television or other visual display medium or the Internet or as part of an EFTPOS system (electronic funds transfer at point of sale). However, the invention is not to be regarded as limited to such applications.

The advertising of goods and services over media such as television and the Internet is now commonplace. With television advertising, the public can often purchase the goods or services so-advertised over the telephone using a credit card facility. With the Internet now well known as an electronic medium and powerful communications tool the seamless system (World Wide Web) linking information on different computers, the general public can readily access the Internet for a wide variety of purposes, including to order numerous consumer goods and/or services online. Once again, payment for these goods and/or services is often by a credit card facility. Yet again, payment of goods at their point of sale by credit or debit cards (EFTPOS) is now common in the marketplace.

A significant disadvantage of telecommunication purchasing is that it does not provide positive identification of individuals which is important for preventing unauthorized access to bank account or credit card details by a person wishing to purchase goods or services fraudulently.

Possibly the most common method of positive identification before a sale is authorized over a telecommunication medium is the use of a code specific for a particular account. These codes, often numeric but can be alphabetical or alphanumeric, are known as PIN numbers (Personal Identification Number) and are used in combination with the particular account number. However, as PIN and account numbers are not dependent on any cross-checking to ensure that they are being quoted over the telecommunication medium by the true proprietor of that PIN number and its associated credit card or bank account, this type of secure transaction is not too difficult to circumvent.

In particular, in current systems utilizing such a magnetic strip credit or debit card, both the users account identification and PIN number are stored on the card. While this data is encoded, the card can be easily duplicated and then used fraudulently in at least two ways;
1. If the fraudulent user holds the card, a transaction can be completed, without a signature or PIN number, by several methods including over the telephone and the Internet using the card number, card name and expiry date.
2. If the fraudulent user knows the PIN number, then a substitute card can be used in ATM's, EFTPOS terminals, etc.

These fraudulent transactions create liability for both the issuing authority—which may be a bank building society or other financial institution—and the cardholder leading to subsequent disputes between the two parties.

Positive identification of an individual is also important for preventing unauthorized access to, or passage from, selected locations or facilities such as international destinations, bank vaults and other restricted areas which include secure buildings, jails, airport terminals, etc.

However, this positive identification of an individual can lead to delays for travellers crossing international borders as officials attempt to confirm the identity of the individual by, for example, manual interrogation, comparison of visual features with photographs in passports, or comparing names with lists of restricted individuals who may be banned from entering or leaving a particular country.

The presently available methods to overcome the above discussed disadvantages can conveniently be summarized as possession of a passport, knowledge of a password, possession of a restricted article such as a pass key, and biometric techniques comparing data on a card offered by an individual to a databank, usually at a remote location, of such information.

For example, prior art solutions relying on a physical attribute of the individual (biometric techniques) include fingerprint analysis, thermograms and DNA analysis. These methodologies are considered less vulnerable to mistaken identity.

One particular method includes comparing the biometric data on a card proffered by an individual to a previously created database of biometric data of authorized individuals. However, this system can still be foiled by individuals who have obtained a biometric card from its righfful owner. Alternatively, a fraudulent user of the card may partially duplicate the card, retaining any credit details but substituting his/her own biometric data for that of the rightful owner of the card. Further, the data obtained from the individual is usually compared to a vast remote databank of such information which is usually difficult and/or slow to locate and access.

A method which overcomes these particular disadvantages is disclosed in Australian Patent Application No. 2001255978 wherein a unique description, which, in one embodiment, includes fingerprint data of that individual, is provided which is then encrypted with an encryption key determined from that fingerprint data and the encrypted data is stored on a card. To obtain verification that the individual offering the card is the same individual whose fingerprint and other data is stored on the card, a fingerprint is taken of the individual, from that fingerprint an encryption key is then determined and that key is used to decrypt the fingerprint data held on the card. The thus-decrypted fingerprint data is then compared with the fingerprint data just taken from the individual and a match can be deemed positive if the two sets of data match.

Whilst this method offers a significant advancement in security, it will always be an advantage to provide new and/or additional features which increase that security.

It is thus a general object of the present invention to provide a more secure method for the positive identification of an individual than the above-mentioned prior art.

According to a first aspect of the present invention, there is provided a method for the positive identification of an individual, said method including:
providing biometric data unique to said individual;
encrypting said biometric data;
embedding the thus-encrypted biometric data within an image of said individual:
providing identification means adapted for carriage with said individual, said identification means having stored thereon said image with embedded said encrypted biometric data;
providing reading means to obtain verification biometric data from a person offering said identification means;
providing decrypting means to decrypt said biometric data embedded within said image;
comparing said verification biometric data with said thus decrypted biometric data;
providing display means to retrieve and display said image from said identification means; and
displaying said image on said display means if said verification biometric data from said person is identical with bald biometric data of said individual stored on said identification means.

Preferably, said image of said individual is encrypted.

Preferably, said image of said individual is a head and shoulders photographic image of said individual.

Preferably, said encrypting said biometric data is undertaken with an encryption key determined from said biometric date.

Preferably, said decrypting means to decrypt said biometric data embedded within said image is an encryption key determined from said verification biometric data.

Preferably, said encryption key is determined from only a part of said biometric data.

Preferably, said biometric data is a fingerprint analysis.

Preferably, said identification means is a card of the type capable of holding information in a machine-readable form.

Optionally, after said reading means has obtained said verification biometric data from said person, said verification biometric data is transmitted to a remote databank for further comparison with biometric data held in said databank.

In one embodiment of the present invention, said individual attends a point of issue for said identification means, such as a bank, where normal identification procedures for banking or credit card facilities must be met before said identification means is issued.

According to a second aspect of the present invention, there is provided a device for use in a method for the positive identification of an individual as hereinbefore described, said device including:
reading means to read said identification means;
decoding means to obtain said biometric data from said identification means;
a facility to obtain said verification biometric data from a person offering said identification means;
comparison means to compare said biometric data with said verification biometric data; and
a display means to retrieve and display said image from said identification means.

Preferably, said device further includes a photographic means to capture and display a current image of said person.

Preferably, said facility is a fingerprint reader.

Preferably, said reading means is a smart card reader assembly.

Preferably, said reading means is, or is incorporated as part of, a computer, mobile telephone, EFTPOS terminal, ATM, or similar terminal.

In those embodiments where said reading means is incorporated into a mobile telephone, said identification means is incorporated into the SIM card of the mobile telephone.

Optionally, said device will allow a maximum of three consecutive attempts to obtain said verification biometric date and compare with said biometric data included within said identification means. If positive identification does not occur within those three attempts, the initial identification is deemed negative.

In a third aspect of the present invention, there is provided a method for a secure transfer of data over a telecommunication medium, said method including:
providing a transmission means to transmit said data from a person desirous of undertaking a transaction to a party requiring to verify said data in order to validate said data before said transaction can be undertaken: and
providing a validation means to ensure that said person is authorized to undertake said transaction;
wherein said validation means returns an authorization for said transaction upon positive identification of said person determined by the method for positive identification as hereinbefore described.

Preferably, said data is financial data of said person.

Preferably, said transmission means includes a terminal remote from said party whereby said person can supply said data to said party and which includes a cellular telephone or wireless data transmission link.

Thus, according to a fourth aspect of the present invention there is provided a terminal for use in a method for a secure transfer of data as hereinbefore described, said terminal including:
transmission means to transmit identification details relevant to said person to said party; and
a facility for said person to provide authentication data of said person with said identification details.

Preferably, said transmission means further includes a credit or debit card slot assembly.

Preferably, said facility includes:
reading means to read said identification means;
decoding means to obtain biometric data from said identification means,
procuring means to obtain said verification biometric data from an individual offering said identification means;
comparison means to compare said biometric data with said verification biometric data;
display means to retrieve and display said image from said identification means; and
authentication means to authenticate said transfer of data.

Preferably, said procuring means is a fingerprint reader.

Preferably, said reading means is a smart card slot assembly wherein said smart card contains said biometric data.

More preferably, said facility further includes a printout means to produce a hard copy for recording details of said transfer-of data.

In one embodiment of this aspect of the present invention, said printout means is a printer either integral with, or separate from, said facility.

In another embodiment of this aspect of the present invention, said printout means is located within said smart card slot assembly. A print head assembly, which may be of a mechanical, thermal, laser or inkjet type, prints a receipt when the receipt is entered (or withdrawn) from the slot assembly subsequent to the completion of the transfer of data and removal of the smart card from the slot assembly. A sensor of either optical or magnetic type detects the presence of the inserted blank receipt and activates the printing process.

Preferably, said receipt is a single, duplicate or triplicate receipt in the form of a “tear off pad”.

More preferably, said receipt is a multiple copy receipt of comparable size to a credit or debit card.

Most preferably, said receipt is in triplicate.

A preferred embodiment of the present invention will now be described with reference to the accompanying drawings, wherein.

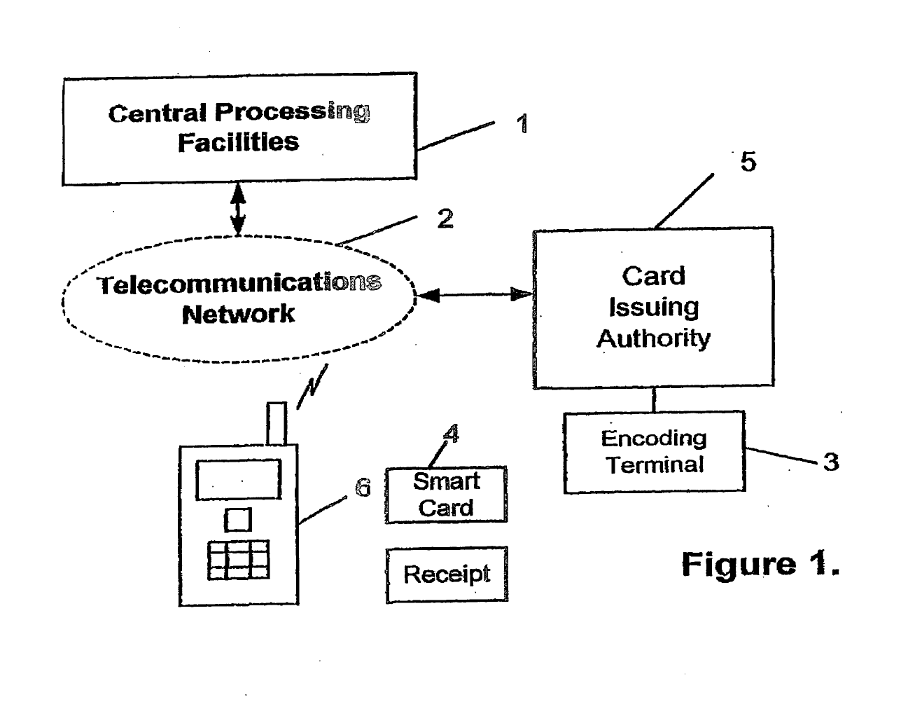

FIG. 1 is a diagrammatic simplistic representation of a terminal which incorporates the present invention for the positive identification of an individual wishing to undertake a financial transaction over that terminal;

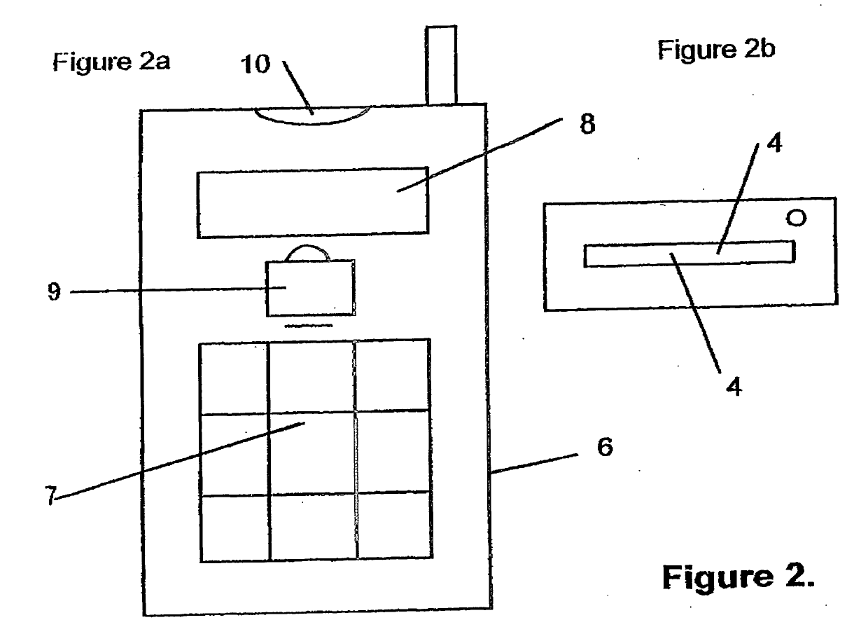

FIG. 2a is a top plan view schematic representation of the terminal of the present invention: and FIG. 2a.

With reference to FIG. 1, there is a central processing unit (1) connected to a cellular telecommunications network (2). An encoder (3) is connected to a smart card (4) issuing terminal (5) which can communicate with the network (2). The encoder (3) incorporates a fingerprint reader and a camera. It will be appreciated by those skilled in the art that each of these components are known and their interconnection possible by any suitable means known in the art. A transaction terminal (6), placed at a merchant's place of business, is also in communication with the network (2). As illustrated in FIGS. 2a & b, the terminal (6) includes a keyboard (7) to enter details of a transaction, a visual display screen (8), a fingerprint reader (9), a smart card reader assembly (10) incorporating a printhead assembly (not illustrated), and a camera (11). The operating software of the terminal (6) includes code to decrypt encrypted information read from the smart card (4). In particular, the code is capable of decrypting text and graphic images. Once again, it will be appreciated by those skilled in the art that each component of the terminal (6) is known and interconnection of the various components can be undertaken by known methods.

An individual wishing to undertake a secure financial transaction using a machine-readable card first obtains a card which incorporates encrypted biometric data, photographic image and financial data of that individual. This is achieved by presenting him- or herself to an institution such as a bank which issues machine-readable “smart” cards. As is usual when applying for a credit or debit card at such an institution, the individual must first provide positive identification which meets the requirements of the institution before proceeding. Once assigned a smart card, biometric data, in particular, fingerprint data, of the individual is taken at the institution using any suitable fingerprint reader known in the art. Although not essential, data can be taken from two fingerprints to minimize any subsequent false rejection that may occur when the present invention is in use at a merchant's place of business. The scanned image of the fingerprint(s), which is represented by a mathematical representation of the ridge pattern, is then compressed and encrypted using any appropriate encryption algorithm known in the art to ensure that it can only be read or compared by first decrypting the date. A photographic image of the individual, usually a head and shoulders image, is also taken and is similarly also compressed and encrypted using any appropriate encryption algorithm known in the art. The encrypted biometric data is then embedded within the encrypted image and, together with the financial details of the individual, are stored in the memory of the smart card.

To undertake a secure purchase using this card (4), at the point of intended purchase, the card (4) is placed in the reader assembly (10) of the terminal (6) whereby the value of the transaction is enter by the merchant using the keyboard (7). The value of the purchase can be displayed on the visual display screen (8). A photograph of the individual bearing the card (4) is taken by the camera (11) and can also be displayed on the screen (8). The account details and encrypted biometric and image data are also read by the terminal (6). The appropriate fingerprint of the individual is then taken at the fingerprint reader (9) of the terminal (6) from which the encryption key is determined. The encrypted fingerprint data and image read from the card (4) is then decrypted using the encryption key just determined. The thus-decoded fingerprint data is compared with the fingerprint data obtained at the terminal (6) and, if they match, the decoded image from the card (4) is displayed on the screen (8) adjacent the photograph previously taken of the individual. The visual comparison of the two images displayed on the screen thus providing a second tier of authentication. If the thus-read fingerprint data is identical with that decoded from the card (4), and if the two images are substantially identical, identification is deemed positive and the financial transaction proceeds. If the comparison is deemed negative, the customer re-presents the finger, or alternative finger if two such fingerprints have been stored on the card (4), for a second scan whereby the comparison process described above is repeated. Although this procedure could be repeated several times, in practice, it is expected that the terminal (6) will be set to allow only a maximum of three consecutive attempts to obtain the verification biometric data and compare with the biometric data included within the smart card (4). If validation does not occur within those three attempts, the identification is deemed negative.

Upon a positive transaction, a receipt is inserted in the reader/printer slot (10) and the details of the transaction are recorded on the receipt. Details of the transaction are also transmitted to the central processing facilities (1) for record purposes.

Although in no way limiting, this embodiment is particularly suitable for point of sale purchasing of goods or services in all markets. The terminal can be a self-contained stand-alone unit, or used in cooperation with a palmtop, laptop or desktop computer or any other unit which includes a visual display unit. Further, the terminal can utilise any convenient telecommunication network, and can be any combination of cellular, satellite, microwave or hard wire telephone or other communication network although, preferably, the terminal will be a wireless communication device incorporating the functionality and convenience of a mobile cellular telephone.

Also, the secure transfer features of the present invention could be attached to existing ATM machines (Automatic Teller Machines) that incorporate a camera facility thus increasing the security of withdrawals therefrom.

Thus the present invention, with its use of both a photographic image and biometric data of an individual originally issued with a credit or debit card or other machine-readable identification means, prevents card fraud or other false identification with a high level of security, ease of use and application.

It will be appreciated that the above described embodiments are only exemplification of the various aspects of the present invention and that modifications and alterations can be made thereto without departing from the inventive concept as defined in the following claims.

What is claimed is:

1. A method for the positive identification of an individual, said method comprising the steps of
providing biometric data unique to said individual;
encrypting said biometric data;
embedding the thus-encrypted biometric data within an image of said individual;
providing an identification arrangement adapted for carriage with said individual, said identification arrangement having stored thereon said image with embedded said encrypted biometric data;
providing a reading device to obtain verification biometric data from a person offering said identification arrangement;
providing a decrypting device to decrypt said biometric data embedded within said image;
comparing said verification biometric data with said thus decrypted biometric data;
providing a display to retrieve and display said image from said identification arrangement; and
displaying said image on said display if said verification data from said person is identical with said biometric data of said individual stored on said identification arrangement.

2. A method as defined in claim 1 wherein said image of said individual is encrypted.

3. A method as defined in claim 1 wherein said image of said individual is a head and shoulders photographic image of said individual.

4. (canceled)

5. A method as defined in claim 1 wherein said encryption key is determined from only a part of said biometric data.

6. A method as defined in claim 1 wherein said decrypting device to decrypt said biometric data embedded within said image is an encryption key determined from said verification biometric data.

7. A method as defined in claim 1 G wherein said biometric data is a fingerprint analysis.

8. A method as defined in claim 1 wherein said identification arrangement is a card of the type capable of holding information in a machine-readable form.

9. A method as defined in claim 1 wherein after said reading device has obtained said verification biometric data from said person and said person has been initially positively identified, said method further includes the step of transmitting said verification biometric data to a remote databank for further comparison with biometric data held in said databank.

10. A device for use in a method for the positive identification of an individual as defined in claim 1, said device including:
said reading device to read said identification arrangement;
a decoding device to obtain said biometric data from said identification arrangement;
a facility to obtain said verification biometric data from a person offering said identification arrangement;
a comparison device to compare said biometric data with said verification biometric data; and
said display to retrieve and display said image from said identification arrangement.

11. A device as defined in claim 10 which further includes a photographic device to capture and display a current image of said person.

12. A device as defined in claim 10 wherein said facility is a fingerprint reader.

13. A device as defined in claim 10 wherein said reading device is a smart card reader assembly.

14. A device as defined in claim 10 wherein said reading device includes a device selected from the group consisting of a computer, mobile telephone, electronic funds transfer at point of sale (EFTPOS) terminal, and automatic teller machine (ATM).

15. A device as defined in claim 14 wherein said reading device includes a mobile telephone.

16. A device as defined in claim 15 wherein said identification arrangement is incorporated into a subscriber identity module (SIM) card of said mobile telephone.

17. A method for a secure transfer of data over a telecommunication medium as defined by claim 1, said method comprising the steps of:
providing a transmission device to transmit said data from a person desirous of undertaking a transaction to a party requiring to verify said data in order to validate said data before said transaction can be undertaken; and
providing a validation device to ensure that said person is authorized to undertake said transaction;
wherein said validation device returns an authorization for said transaction upon positive identification of said person determined by the method for positive identification as defined in claim 1.

18. A method as defined in claim 17 wherein said data is financial data of said person.

19. A method as defined in claim 17 wherein said transmission device includes a terminal remote from said party whereby said person can supply said data to said party and which includes one of a cellular telephone and wireless data transmission link.

20. A terminal for use in a method for a secure transfer of data as defined in claim 17, said terminal including:
said transmission device to transmit identification details relevant to said person to said party; and
a facility for said person to provide authentication data of said person with said identification details.

21. A terminal as defined in claim 20 wherein said transmission device further includes one of a credit card slot assembly and debit card slot assembly.

22. A terminal as defined in claim 20 wherein said facility includes:
a reading device to read said identification arrangement;
a decoding device to obtain biometric data from said identification arrangement;
a procuring device to obtain said verification biometric data from an individual offering said identification arrangement;
a comparison device to compare said biometric data with said verification biometric data;
said display to retrieve and display said image from said identification arrangement; and
an authentication device to authenticate said transfer of data.

23. A terminal as defined in claim 22 wherein said procuring device is a fingerprint reader.

24. A terminal as defined in claim 22 wherein said reading device is a smart card slot assembly wherein said smart card contains said biometric data.

25. A terminal as defined in claim 20 wherein said facility further includes a printout device to produce a hard copy for recording details of said transfer of data.

26. A terminal as defined in claim 25 wherein said printout s device is a printer which is one of integral with and separate from, said facility.

27. A terminal as defined in claim 25 wherein said printout device is located within said smart card slot assembly.

28. A terminal as defined in claim 27 wherein said printout device includes a print head assembly which prints a receipt when said receipt is entered or withdrawn from said slot assembly subsequent to the completion of said transfer of data.

29. A terminal as defined in claim 28 wherein said print head assembly includes one of an optical and magnetic sensor which is adapted to detect the presence of an inserted blank said receipt and activate the printing process.

30. A terminal as defined in claim 29 wherein said printing process is selected from the group consisting of a mechanical, thermal, laser and inkjet process.

31. A terminal as defined in claim 28 wherein said receipt is one of a single, duplicate and triplicate receipt in the form of a tear-off pad.

32. A terminal as defined in claim 31 wherein said receipt is a multiple copy receipt of comparable size to a credit or debit card.

33. (canceled)
